(19) United States
(12) Patent Application Publication
(10) Pub. No.: US 2009/0010502 A1
(43) Pub. Date: Jan. 8, 2009

(54) Vehicle Occupant Protection System

(75) Inventors: Thomas Hackbarth, Blaustein (DE); Martin Lanzerath, Denkendorf (DE); Manfred Linssen, Holzguenz (DE); Clark Ruedebusch, Holzgerlingen (DE); Matthias Struck, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/088,356

(22) PCT Filed: Sep. 15, 2006
(86) PCT No.: PCT/EP2006/009001

§ 371 Date: Jul. 18, 2008

(30) Foreign Application Priority Data
Sep. 30, 2005 (DE) 10 2005 047 137.4

(51) Int. Cl. G06K 9/00

(52) U.S. Cl. 382/124

(57) ABSTRACT

An occupant protection system or comfort system for a vehicle having a plurality of adaptive protection system or comfort system components which are assigned to one respective vehicle seat. The system components and which can be adjusted by a stored safety and/or comfort profile relating to a person when the person is identified by a person identifying device for detecting biometric identification features of parts of a vehicle occupant's body. The person identifying device has a biometric sensor for identifying the vehicle occupant, as well as an arrangement for unambiguously assigning the vehicle occupant to a vehicle seat.

This application is a national stage of PCT International Application No. PCT/EP2006/009001, filed Sep. 15, 2006, which claims priority under 35 U.S.C. § 119 to German Patent Application No. 10 2005 047 137.4, filed Sep. 30, 2005, the entire disclosure of which is herein expressly incorporated by reference.

### BACKGROUND AND SUMMARY OF THE INVENTION

The present invention relates to a vehicle occupant protection system and/or comfort system comprising a plurality of adaptive protection system components and/or comfort components which are assigned to a vehicle seat.

In modern vehicles, numerous functions can be adapted to the requirements and desires of the vehicle occupants. Comfort systems may include, for example, seat adjustment, mirror adjustment and steering wheel adjustment devices. An air conditioning system may, in particular, regulate the temperature of the passenger compartment, ventilation and heating of the seat. Furthermore, it is possible to set a shifting characteristic on a drive of the vehicle, and a damping characteristic on the chassis. Restraint systems which promote safety can be adapted to the size, weight and age of the vehicle occupants.

Further adaptations can also be found in the fields of entertainment, communications and display. For example, it is possible to make adjustments with respect to a transmitter, including the volume, the sound, a telephone number list, the color and/or a language. In the case of a navigation system, it is possible to predefine the frequency of routes and a route profile.

However, a large number of other adaptable functions can also be adjusted in a vehicle, which results in a very complex user profile that depends not only on the vehicle occupant but also on his current sitting position on a driver's seat, front seat passenger's seat or a rear seat. Automatic recognition of the vehicle occupants makes it possible to set a previously stored vehicle-occupant-related user profile so that a large numbers of adjustment measures can be replaced by a single action. Biometric systems can be used for such recognition system, as well as, for example, the inputting of a PIN. The most well known methods for biometric person recognition are fingerprint recognition methods.

German patent document 102005021171.2, which has not yet been published, discloses a vehicle occupant protection system and/or comfort system which comprises a plurality of adaptive protection system components and/or comfort components which are assigned to one particular seat, and which can be adjusted by means of a safety and/or comfort profile. The safety profile and/or comfort profile relates to a vehicle occupant who is occupying the particular seat, and can be activated by means of an authentication system. The authentication system comprises a plurality of person identifying devices which are assigned to particular seat, for the purpose of sensing biometric identification features of parts of a vehicle occupant's body. The sensed biometric identification features can be used to identify the vehicle occupant and to assign him or her to that seat.

In contrast to camera based methods, such as for example face recognition or iris recognition devices, with customary fingerprint readers unless a separate fingerprint reader is assigned to each vehicle seat, as described in the German patent document 102005021171.2, it is not possible to recognize both the identity and sitting position of a vehicle occupant and at the same time. Customary fingerprint readers are composed of a rectangular sensor panel with a trough shaped border which corresponds approximately to the shape of a finger or fingertip. This border is intended to ensure that when the finger which is to be recognized is placed on the device it is always placed with approximately the same orientation as when the fingerprint was first stored (referred to as the enrollment). This simplifies the comparison between the stored data record and the currently generated data since the orientation of the pattern of lines on the skin then differs only slightly.

If a user gets into a vehicle and touches a customary fingerprint reader (arranged, for example, in the center console), it is then not possible to know unambiguously whether his user profile is to be adjusted for the driver's side or the front seat passenger's side. It would be possible, for example, that when a small person who is seated on the front seat passenger's seat is recognized, the driver's seat is pushed into the front position which is suitable for this person, even though a large person is sitting there.

Even the possibility of assigning the user profile of the driver's side to a finger on the right hand of a left-handed person, and of assigning the user profile of the front seat passenger's side to a finger on the left hand can lead to incorrect assignment of sides if the vehicle occupant uses the wrong hand but his wrist is oriented in such a way that the finger fits into the trough. The installation of a plurality of fingerprint readers on the respective outer side (for example in the internal door handle), also entails the risk of incorrect assignment if, for example, a vehicle occupant bends toward the other side in order to hold open the door for another passenger.

European patent document EP 1 390 904 B1 discloses a mobile communication terminal with a user interface having a biometric sensor for recognizing a fingerprint. The biometric sensor is configured to sense the orientation of a finger and to input a specific control instruction, dependent on the sensed orientation of the finger, into the mobile communication terminal in order to control the latter. This significantly simplifies operator control of the communication terminal, in particular recognition of an authorized person by means of a fingerprint structure which is characteristic of the person.

One object of the present invention is to provide a vehicle occupant protection system and/or comfort system which ensures that a vehicle occupant is identified and the vehicle occupant is unambiguously assigned to the correct vehicle seat.

Another object of the invention is to provide such a vehicle system comprising a plurality of adaptive protection system components and/or comfort systems components, which are assigned to one respective vehicle seat, and which can be adjusted by means of a stored safety profile and/or comfort profile relating to a person when the person is identified by a person identifying device for detecting biometric identification features of parts of a vehicle occupant's body.

These and other objects of the invention are achieved by the vehicle occupant protection and/or comfort system according to the invention, in which the person identifying device has a biometric sensor for identifying the vehicle occupant. Means are provided for unambiguously assigning the vehicle occupant to a specific vehicle seat. The vehicle occupant protection and/or comfort system comprises a plurality of adaptive protection system components and/or comfort components which are assigned to one respective vehicle seat, and which can be adjusted by means of a stored safety and/or comfort profile relating to a person when the person is identified by a person identifying device for detecting biometric identification features of parts of a vehicle occupant's body. The vehicle occupant protection and/or comfort system requires only one biometric sensor in the vehicle for identifying the vehicle occupant. No further biometric sensors are used to unambiguously assign the vehicle occupant to a specific vehicle seat.

The invention can be implemented effectively with little expenditure and cost, since a separate biometric sensor need not be installed for each vehicle seat. In addition, it is of course possible to use, in the vehicle occupant protection system and/or comfort system, a plurality of biometric sensors which detect a wide range of different identification features of parts of the vehicle occupant's body.

In one embodiment of the invention, the biometric sensor is a fingerprint reader which can detect a fingerprint with various finger orientations on a sensor panel of the fingerprint reader, and the particular vehicle seat occupied by the vehicle occupant can be determined by means of the sensed finger orientation. The means for unambiguously assigning the vehicle occupant to a specific vehicle seat are therefore integrated into the fingerprint reader in this embodiment of the invention. The fingerprint reader thus carries out two functions at the same time: it identifies the vehicle occupant, and ambiguously assigns the vehicle occupant to the vehicle seat which he or she in fact occupies.

In one embodiment of the invention, the biometric sensor is a fingerprint reader, and the means for unambiguously assigning the vehicle occupant to a vehicle seat comprise a first electrically conductive electrode structure in the region of the fingerprint reader and a second electrically conductive electrode structure in the region of the vehicle seat. With this configuration, it is possible to determine occupation of the vehicle seat by the vehicle occupant from an electrical measurement between the two electrode structures. The identification of the vehicle occupant and the assignment of the vehicle occupant to a vehicle seat are carried out using two different physical measuring principles. The electrically conductive electrode structures are frequently already provided in vehicles for other functional applications so that they possibly do not need to be retrofitted.

### BRIEF DESCRIPTION OF THE DRAWINGS

The invention will be explained in more detail below with reference to a plurality of exemplary embodiments in the figures, of which:

FIG. 1 shows characteristic finger orientations on a fingerprint reader;

FIGS. 2a and 2b show arrangements of sectors on a sensor panel of a fingerprint reader;

FIG. 3 is a flowchart of an assignment of a vehicle occupant to a vehicle seat;

FIGS. 4a and 4b shown perspective illustrations of exemplary embodiments of fingerprint readers; and

FIG. 5 is a schematic illustration of a detail of an arrangement comprising a vehicle seat and a fingerprint reader.

### DETAILED DESCRIPTION OF THE DRAWINGS

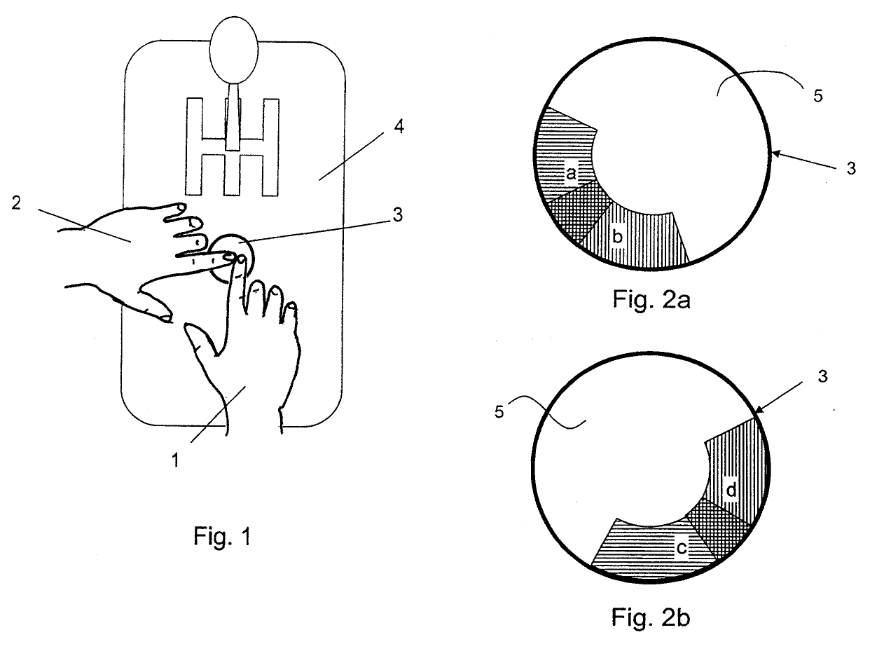

FIG. 1 shows typical hand orientations and finger orientations of a right hand 1 and of a left hand 2 of a vehicle occupant on a fingerprint reader 3. The fingerprint reader 3 is a component of a person identifying device of a vehicle occupant protection and/or comfort system having a plurality of adaptive protection system components and/or comfort components which are assigned to one respective vehicle seat 8 (illustrated in FIG. 5). The adaptive protection system components and/or comfort components can be adjusted by means of a stored safety profile and/or comfort profile relating to a person when the person is identified by means of a person identifying device for detecting biometric identification features of parts of a vehicle occupant's body. In this exemplary embodiment, the vehicle occupant occupies the left front vehicle seat 8. The fingerprint reader 3 is advantageously integrated into a center console 4.

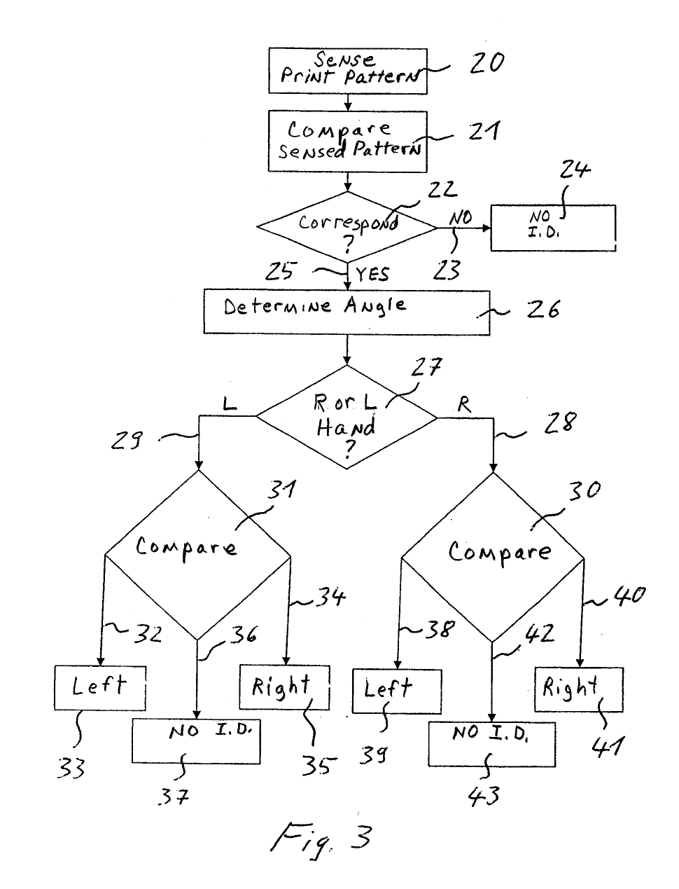

FIG. 2a and b show by way of example the sectors a, b, c and d on a sensor panel 5 of the fingerprint reader 3 for detecting the finger orientation of a vehicle occupant. In this exemplary embodiment, the sectors a, b, c and d are embodied as angle sectors. By evaluating the finger orientation detected by the fingerprint reader 3, it is possible for a seat to be allocated. The vehicle occupant occupies the vehicle seat 8 at either the left or right front of the vehicle.

If a finger on the right hand of the vehicle occupant with an orientation within the sector b as per FIG. 2a is sensed, the vehicle occupant is assigned to the left hand vehicle seat 8. The same applies to a finger on the left hand which is sensed with an orientation in the sector a. The sectors a and b can overlap here. Allocation to the right hand vehicle seat 8 occurs, as illustrated in FIG. 2b, when the orientation of a left hand finger within the sector c is recognized, or the orientation of a right hand finger within the sector d is recognized. Here too, the sectors c and d can overlap. However, the sectors a, b, c and d for fingers on the same hand, that is to say the sectors a and c for the fingers on the left hand and the sectors b and d for the fingers on the right hand, must be clearly separated from one another. This permits the vehicle occupant to allocate his personal user profile to his current sitting position, (i.e., the vehicle seat 8 occupied by the vehicle occupant), while maintaining a comfortable position of the hand and arm. Incorrect allocation is avoided because it is impossible to adopt finger orientation outside the specified angular ranges while maintaining a natural, comfortable position of the body, arm and hand since the degrees of freedom for this are restricted by the limited spatial conditions in the vehicle.

The sensor panel 5 of the fingerprint reader 3 is preferably of circular design. A trough in a region of the sensor panel 5 which would require a particular orientation of a finger is not necessary and therefore not provided. As a result, the vehicle occupant may position the finger to be recognized in any desired orientation which is comfortable. The surface of the sensor panel 5 of the fingerprint reader 3 should just have the dimension such that the fingerprint can be recognized with all the possible finger orientations. The circular configuration of the sensor panel 5 can be achieved if the sensor panel 5 is itself of circular shape, or if a sensor panel 5 with any desired geometry is provided with a circular cover (which may be, for example, a component of the center console 4). As a rule the sensor panel 5, for example a CMOS sensor array, has a rectangular configuration, due to the manufacturing process.

A flowchart for generating a seat assignment is illustrated in FIG. 3. At first, a pattern of lines on the skin of a finger of a hand 1, 2 is sensed 20 by means of the sensor panel 5 of the fingerprint reader 3 with a subsequent comparison 21 between the currently sensed pattern of lines on the skin and the patterns of lines on the skin which are stored in the person identifying device. A decision 22 is made. If no correspondence 23 is detected between the currently sensed pattern of lines on the skin and a pattern of lines on the skin which is stored in the person identifying device, personal identification 24 does not take place and a seat is not assigned. If, on the other hand, correspondence 25 is detected between the currently sensed pattern of lines on the skin and a pattern of lines on the skin which is stored in the person identifying device, the angle between the currently sensed pattern of lines on the skin and the pattern of lines on the skin identified by means of the person identifying device is determined 26. According to an assignment 27, the finger can either be assigned to the right hand 1 (path 28), or the left hand 2 (path 29).

A comparison 30, 31 between the respectively sensed determination 26 of an angle and the sectors a, b, c and d on the sensor panel 5 of the fingerprint reader 3 is then carried out in each case for both paths 28, 29. (The sectors a, b, c and d of the sensor panel 5 of the fingerprint reader 3 are illustrated in more detail in FIG. 2.) By the comparison 30, 31 it is possible to determine unambiguously which finger of which hand 1, 2 was sensed in which sector a, b, c and d of the sensor panel 5 of the fingerprint reader 3. If a finger on the left hand 2 is sensed in the sector a, (path 32), an assignment 33 of the vehicle occupant to the left hand vehicle seat 8 is made. If, on the other hand, a finger on the left hand 2 is sensed in the sector c, (path 34), an assignment 35 of the vehicle occupant to the right hand vehicle seat 8 is made. If a finger on the left hand 2 is sensed outside the sectors a, b, (path 36), personal identification 37 does not take place.

Corresponding systematization applies accordingly to path 28 for the right hand 1. If a finger on the right hand 1 is sensed in the sector b, (path 38), an assignment 39 of the vehicle occupant to the left hand vehicle seat 8 is made. If, on the other hand, a finger on the right hand 1 is sensed in the sector d, see path 40, an assignment 41 of the vehicle occupant to the right hand vehicle seat 8 is made. If a finger on the right hand 1 is sensed outside the sectors c, d, (path 42), no personal identification 43 takes place.

A further possibility for assignment of a seat is to evaluate tilting of the finger on the sensor panel 5. When the fingerprint reader 3 is arranged on the center console 4 in a natural, comfortable position of the arm and hand, for example, the finger on the right hand of the vehicle occupant sitting on the left hand vehicle seat 8 is tilted somewhat outward and away from the thumb so that a region of the pattern of lines on the skin which is displaced somewhat to the right from the center of the fingertip rests on the sensor panel 5. If the vehicle occupant on the left hand vehicle seat 8 uses a finger on his left hand (that is, the side of the body on the outside of the vehicle), he must reach over his body. This leads to a raising of the elbow. In the process, the finger automatically tilts inward toward the thumb. A part of the pattern of lines on the skin which has been moved to the right of the center then also rests on the sensor panel 5.

For vehicle occupants on the right hand vehicle seat 8, the conditions are precisely laterally reversed. Therefore, if a finger with a displacement of the pattern of lines on the skin to the left of the center is recognized, the personal profile is to be assigned to the right hand vehicle seat 8. When the pattern of lines on the skin is first sensed, referred to as enrolment, the pattern of lines on the skin must be picked up from a large area of the fingertip on a correspondingly large sensor panel 5. For this purpose, during the sensing process the finger would have to be rolled through an extremely large angle, for example through +/−45° about its longitudinal axis. The procedure here is similar to that which occurs with colored fingers on paper when fingerprinting and photographing someone.

Rotating the pattern of lines on the skin and tilting of the finger by means of the lateral displacement of the pattern of lines on the skin in order to determine the finger orientation so as to determine the assignment of seats can be applied individually or in combination, in particular for plausibility checking.

A further possible way of recognizing a vehicle occupant and assigning his or her profile is to the current vehicle seat 8 is to carry out an electrical measurement between the electrically conductive sensor panel 5 and one or more electrically conductive areas or structures in the direct vicinity of the respective vehicle occupant. The sensor panel 5 itself and/or a cover in a surrounding area of the sensor panel 5 must be made electrically conductive for this purpose. An electrically conductive sensor panel 5 is always provided in the customary CMOS fingerprint readers 3, but is generally not provided in the rarely used fingerprint readers 3 which are based on an optical method.

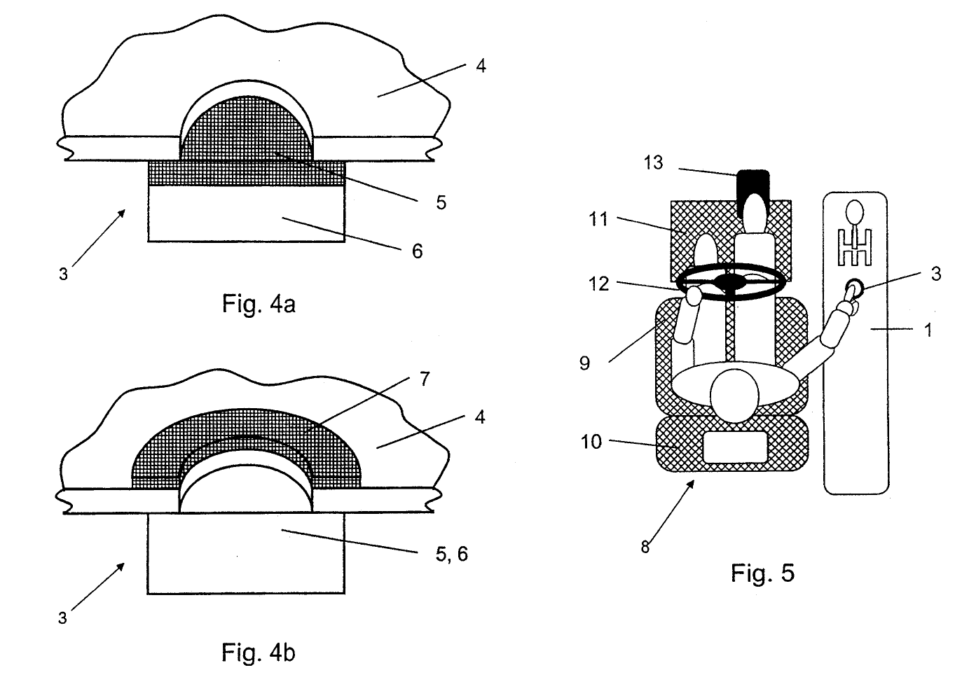

An exemplary embodiment of a fingerprint reader 3 with a conductive sensor panel 5 on a carrier structure 6 embedded in a circular opening in the nonconductive center console 4 is shown by FIG. 4a. An exemplary embodiment of a fingerprint reader 3 without a conductive sensor panel 5 is illustrated in FIG. 4b in which a circular, conductive electrode structure 7 is embodied as a narrow border around an opening for the sensor panel 5 on the nonconductive center console 4.

The components which are suitable for an electrical measurement are illustrated in FIG. 5. The fingerprint reader 3 which is arranged in the center console 4 comprises an electrically conductive electrode structure. A further electrically conductive electrode structure is arranged in the vicinity of the vehicle occupant's body in the region of the vehicle seat 8, in particular in a seat surface 9, in a seat backrest 10, in a footwell 11, on a steering wheel 12, in a door area (not illustrated in more detail) and/or on the pedals 13. These electrically conductive electrode structures in the vicinity of the vehicle occupant may be, for example, films, plates, wires, grid networks or other electrically conductive coatings. An example of this is a conductive mat which is located in the footwell or in the upholstery of a seat and which will be used in future vehicles by the applicant in, for example, the capacitive classification of vehicle occupants on the front seat passenger's side. Conductive electrode structures which will measure the vehicle occupant position in relation to the seat backrest 10 can also be arranged in the vehicle seat 8 and in an inner roof lining.

For electrical measurement, the two electrode structures must be connected to different electrical potential. A change in the electric current, capacitance or inductance between the conductive sensor panel 5 or the conductive cover and the other conductive electrode structure which is near to the vehicle occupant can be measured when a finger is sensed by the fingerprint reader 3. The current, capacitance or inductance change by virtue of the fact that when a finger approaches or is in contact the conductivity or the dielectric constant or the permeability of the vehicle occupant differs from the corresponding values of the air in the passenger compartment. This makes it possible to detect unambiguously which vehicle seat 8 the fingerprint recognition process was triggered from. The electrical measurement can comprise the sensing of one or more electrical variables.

The orientation or the tilting of the finger can be sensed and the electrical measurement can respectively be applied, individually or in combination for the assignment of a seat. Given a combined application, the assignment of a seat can also occur unambiguously if one of the two methods does not permit reliable assignment, for example given inadequate conductivity of the vehicle occupant owing to thick, insulating clothing or finger orientations being detected in the boundary region between two sectors a, b, c and d or outside permitted sectors a, b, c and d.

Both methods are suitable not only for use with fingerprint readers but also for other contact based biometric methods such as, for example, detecting the geometry of hands or fingers since, here too, it is possible to determine the orientation and to carry out an electrical measurement. However, it is not possible to sense tilting.

The fingerprint reader does not necessarily have to be arranged in the center console 4 but it is advantageous if it can be reached equally satisfactorily by both vehicle occupants in the front of the vehicle and is located approximately in the center between them. Further possible locations are, for example, in the cockpit or in the center armrest.

The vehicle occupant protection system and/or comfort system according to the invention permits vehicle occupants to be recognized with unambiguous allocation of seats using only one biometric sensor. However, it is also possible to use a plurality of biometric sensors in the passenger compartment. The recognition of vehicle occupants can, in particular, also be extended to the passengers in the rear of the vehicle if at least one further biometric sensor is advantageously arranged there, behind the front biometric sensor, and cannot be reached easily (or reached at all) by the passengers in the front of the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. An occupant protection system or comfort system for a vehicle having a plurality of adaptive protection system or comfort system components which are assigned to a respective vehicle seat and which can be adjusted by means of a stored safety or comfort profile relating to a person when the person is identified by a person identifying device for detecting biometric identification features of parts of a vehicle occupant's body, wherein:
the person identifying device has a biometric sensor for identifying the vehicle occupant; and
a device is provided which unambiguously assigns the vehicle occupant to a vehicle seat.

13. The system according to claim 12, wherein:
the biometric sensor is a fingerprint reader which can detect a fingerprint with variable finger orientation on a sensor panel of the fingerprint reader; and
the vehicle seat which is occupied by the vehicle occupant is determined based on the sensed finger orientation.

14. The system according to claim 13, wherein the sensor panel of the fingerprint reader is divided into sectors for determining the finger orientation.

15. The system according to claim 13, wherein the fingerprint reader also senses tilting of the finger about a longitudinal axis of the finger.

16. The system according to claim 13, wherein the sensor panel of the fingerprint reader has a round configuration.

17. The system according to claim 12, wherein the biometric sensor is arranged in a center console between the two front vehicle seats.

18. The system according to claim 12, wherein:
the biometric sensor is a fingerprint reader;
the device which unambiguously assigns the vehicle occupant to a vehicle seat comprises an electrically conductive electrode structure in the region of the fingerprint reader and a further electrically conductive electrode structure in the region of the vehicle seat;
occupation of the vehicle seat is determined by the vehicle occupant from an electrical measurement between the two electrode structures.

19. The system according to claim 18, wherein the electrical measurement comprises measuring one of an electric current, a capacitance and an inductance.

20. The system according to claim 18, wherein the electrode structure is arranged in proximity to at least one of the vehicle seat, a seat surface, a seat backrest, a footwell, a steering wheel, a door area, and an inner roof lining of the vehicle.

21. The system according to claim 12, wherein the biometric sensor detects the geometry of at least one of hands and fingers.

22. The system according to claim 12, further comprising at least one additional biometric sensor which is arranged in vehicle seats in a rear area of the vehicle.

23. A vehicle system comprising:
a plurality of adaptive protection system or comfort system components that are assigned to a respective vehicle seat, and which can be adjusted in response to a stored profile relating to a person who occupies the vehicle seat;
a person identifying device which includes a biometric sensor, which identifies a vehicle occupant, by detecting biometric identification features of parts of a vehicle occupant's body; and
a device which unambiguously assigns the vehicle occupant to a vehicle seat.

24. The system according to claim 23, wherein:
the biometric sensor is a fingerprint reader which can detect a fingerprint with variable finger orientation on a sensor panel of the fingerprint reader; and
the vehicle seat which is occupied by the vehicle occupant is determined based on the sensed finger orientation.

25. The system according to claim 24, wherein the sensor panel of the fingerprint reader is divided into sectors for determining the finger orientation.

26. The system according to claim 25, wherein the fingerprint reader also senses tilting of the finger about a longitudinal axis of the finger.

27. The system according to claim 23, wherein:
the biometric sensor is a fingerprint reader;
the device which unambiguously assigns the vehicle occupant to a vehicle seat comprises an electrically conductive electrode structure in the region of the fingerprint reader and a further electrically conductive electrode structure in the region of the vehicle seat;
occupation of the vehicle seat is determined by the vehicle occupant from an electrical measurement between the two electrode structures.

28. The system according to claim 23, wherein the biometric sensor detects the geometry of at least one of hands and fingers.
